(19) United States
(12) Patent Application Publication
(10) Pub. No.: US 2014/0092005 A1
(43) Pub. Date: Apr. 3, 2014

(54) IMPLEMENTATION OF AN AUGMENTED REALITY ELEMENT

(71) Applicants: Glen Anderson, Beaverton, OR (US); Giuseppe Raffa, Portland, OR (US); Lucas Ainsworth, Portland, OR (US); Adam Jordan, El Cerrito, CA (US); Wendy March, Portland, OR (US); Lama Nachman, Santa Clara, CA (US); Muki Hansteen-Izora, Portland, OR (US); Yi Wu, San Jose, CA (US); Ashwini Asokan, Sunnyvale, CA (US); Rahul Shah, San Francisco, CA (US); Ana Rosario, San Francisco, CA (US)

(72) Inventors: Glen Anderson, Beaverton, OR (US); Giuseppe Raffa, Portland, OR (US); Lucas Ainsworth, Portland, OR (US); Adam Jordan, El Cerrito, CA (US); Wendy March, Portland, OR (US); Lama Nachman, Santa Clara, CA (US); Muki Hansteen-Izora, Portland, OR (US); Yi Wu, San Jose, CA (US); Ashwini Asokan, Sunnyvale, CA (US); Rahul Shah, San Francisco, CA (US); Ana Rosario, San Francisco, CA (US)

(21) Appl. No.: 13/631,304

(22) Filed: Sep. 28, 2012

(51) Int. Cl. G06F 3/01

(52) U.S. Cl. 345/156

(57) ABSTRACT

Systems and methods may provide for an implementation of an augmented reality element. A logic architecture may be employed to coordinate the implementation of the augmented reality element based on an input and in response to when a user is to view the augmented reality element. The logic architecture may also be employed to perform an association between the input and the implementation of an augmented reality element, wherein the association is to be defined by the user. Additionally, the logic architecture may be employed to include a guide input to guide the implementation, for example a guide input to guide the conduct, of the augmented reality element.

### BACKGROUND

Embodiments generally relate to implementations of augmented reality (AR) elements. More particularly, embodiments relate to the coordination of the implementation of AR elements based on various inputs and in response to a user viewing the AR element. Embodiments also relate to an association, which is to be defined by the user, between the input and the implementation of the AR element.

In certain consumer devices, a user may interact with an AR element, such as an animated character. The implementation of the AR element, however, may be relatively static (e.g., performed whether or not the user is to view, or is viewing, the AR element), and may lead to unnecessary utilization of resources, such as processor and power resources (e.g., reducing battery life). Other limitations of conventional AR implementations may also negatively impact the user experience.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is an example of an approach to coordinate an implementation of an augmented reality (AR) element based on an input and in response to when a user is to view the AR element according to an embodiment;

FIG. 2 is a screenshot of an example of an approach to perform an association between an input and an implementation of an AR element according to an embodiment;

FIG. 3 is a block diagram of an example of a method of an AR element implementation according to an embodiment;

FIG. 4 is a flowchart of an example of a method of coordinating an implementation of an AR element according to an embodiment;

FIG. 5 is a flowchart of an example of a method of performing an association between an input and an implementation of an AR element according to an embodiment;

FIG. 6 is a block diagram of an example of a logic architecture according to an embodiment;

FIG. 7 is a block diagram of an example of a control system according to an embodiment;

FIGS. 8A to 8F are screenshots of examples of implementations of AR elements according to embodiments;

FIG. 9 is a block diagram of an example of a processor according to an embodiment; and

FIG. 10 is a block diagram of an example of a system according to an embodiment.

### DETAILED DESCRIPTION

Embodiments may include a computer-implemented method in which an input may be received. The computer-implemented method may coordinate an implementation of an augmented reality (AR) element based on the input and in response to when a user is to view the AR element. In addition, the computer-implemented method may perform an association between the input and the implementation of the AR element, wherein the association is to be defined by a user. Moreover, the computer-implemented method may employ guide data to guide the implementation (e.g., conduct) of the AR element.

Embodiments may also include a computer-readable storage medium having a set of instructions, which, if executed by a processor, may cause a processor to coordinate the implementation of the AR element based on the input and in response to when a user is to view the AR element. The instructions, if executed, may cause a processor to determine the implementation of the AR element. The instructions, if executed, may cause a processor to determine when the user is to view the AR element. In addition, the instructions, if executed, may cause a processor to perform an association between the input and the implementation of the AR element, wherein the association is to be defined by the user. In one embodiment, the user is to designate one or more of the input and the implementation of the AR element to be employed in the association. In addition, the instructions, if executed, may cause a processor to employ the input and the implementation of the AR element in the association. Furthermore, the instructions, if executed, may cause a processor to employ a guide input to guide the implementation of the AR element.

Embodiments may also include an apparatus having logic to coordinate the implementation of the AR element based on the input and in response to when the user is to view the AR element. The apparatus may include a coordinator module to coordinate the implementation of the AR element based on the input and in response to when the user is to view the AR element. In addition, the apparatus may include a pair module to perform an association between the input and the implementation of the AR element, wherein the association is to be defined by the user. Moreover, the apparatus may include a guide module to guide the implementation of the AR element.

Embodiments may also include a system having logic to coordinate the implementation of the AR element based on the input and in response to when the user is to view the AR element. In addition, the system may include logic to perform an association between the input and the implementation of the AR element, wherein the association is to be defined by the user. Moreover, the system may include logic to guide the implementation of the AR element. In one embodiment, the system may include logic in combination with one or more system components, such as a power supply, a display, a user interface, system memory, storage, network interface component, and so on, or combinations thereof. Moreover, the system may include one or more sensors, such as a motion sensor, an audio sensor, an image sensor, a touch sensor, a climate sensor, and so on, or combinations thereof.

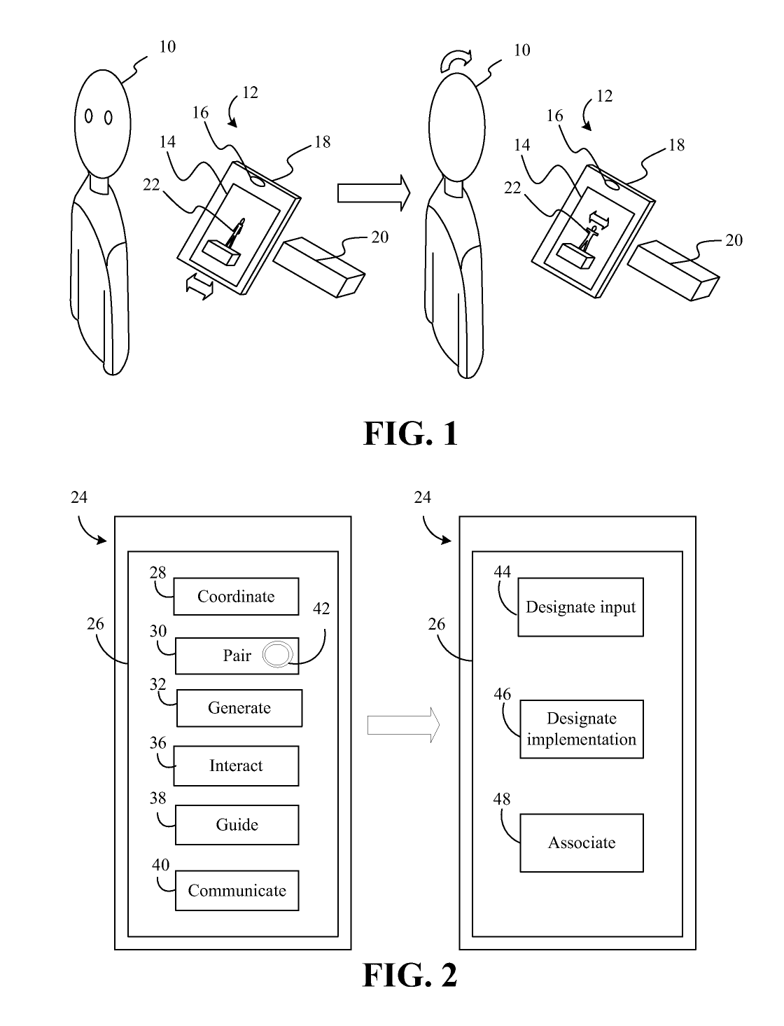

FIG. 1 shows an approach to coordinate an implementation of an AR element based on an input and in response to when a user is to view the AR element. In the illustrated example, an apparatus 12 includes a screen 14, a front-facing camera 16, and a rear-facing camera 18. The illustrated apparatus 12 may include any video display platform such as a laptop, personal digital assistant (PDA), wireless smart phone, media content player, imaging device, mobile Internet device (MID), any smart device such as a smart phone, smart tablet, smart TV and so on, or any combination thereof. The illustrated rear-facing camera 18 is configured to capture an image of a real (e.g., physical) object 20, which is in the visual field of a user 10. The user 10 is able to observe an AR element 22 (e.g., animated character) presented on the screen 14. The apparatus 10 may include an AR rendering system, for example including a program to make AR elements blend with the environment in convincing ways. Moreover, the apparatus 10 may include an environmental characteristic recognition system employing image analytics, for example to recognize a horizontal surface so that the AR element may not cross the surface.

The user 10 may provide a gesture input, such as a motion gesture, by shaking the apparatus 12. A sensor of the apparatus 10, such as an accelerometer or gyroscope, may detect the gesture. The apparatus 10 may interpret the gesture, for example determining that the motion gesture is indicative of an AR shaking effect. Accordingly, the apparatus 10 may create a rendering that reflects the AR element behavior in accordance with the motion gesture. In one embodiment, the AR element 22 does not perform the conduct until the user 10 is to view, or is viewing, the AR element 22. In this regard, the apparatus 10 may include a face detection system to detect the user 10, or a portion of the user 10. For example, the front-facing camera 16 may be employed to determine that the user 10 is facing away from the screen 14, wherein the AR element 22 does not perform the conduct under such a condition. When the user 10 turns around to face the screen 14, on the other hand, the front-facing camera 16 may be employed to detect that the user 10 is to view the AR element. The AR element 22 may then perform the conduct (e.g., shake) based on the input and in response to when the user views the AR element 22.

Turning to FIG. 2, a screenshot of an example of an approach to define an association between an input and an implementation of an AR element is shown. In the illustrated example, an apparatus 24 includes a screen 26, which may include a touch screen. The screen 26 may present one or more tabs to a user. In the illustrated example, the screen 26 presents a coordinate tab 28, a pair tab 30, a generate tab 32, a guide tab 38 and a communicate tab 40. The coordinate tab 20 may enable the user to coordinate the implementation of the AR element based on the input and in response to when the user is to view the AR element. For example, selecting the illustrated coordinate tab 20 permits the user to enable, or disable, the coordination to be in response to when a user is to view the AR element. Similarly, the coordinate tab 20 may permit the user to enable, or disable, a determination of the implementation of the AR element. Moreover, the coordinate tab 20 permits the user to defer to, or include, user-defined data from the pair tab 30.

The illustrated pair tab 30 permits the user to perform an association between the input and the implementation of the AR element. For example, the user may select pair tab 30 by touching the screen 26 at area 42. The user may then be presented with a designate input tab 44, a designate implementation tab 46, and an associate tab 48. In one embodiment, the user may select the designate input tab 44 to designate the input to be employed in the association. For example, the user may designate a motion gesture, such as a shake motion gesture, to be employed in the association. The user may select the input from storage, for example from a database of inputs, or may create a new input to be stored and employed. The user may also select the designate implementation tab 46, which permits the user to designate an implementation to be employed in the association. For example, the user may select an implementation, such as AR element conduct, from a database, or may create a new implementation to be stored and employed. The user may also select the associate tab 48, which may employ the input and the implementation in the association. For example, the user may define that the designated input and the designated implementation is to be associated, or related, with each other.

The generate tab 32 permits the user to define a generation of the AR element, an AR message, a virtual object, a sensory output, and so on, or combinations thereof. For example, the user may define what AR elements are to be generated, the process of notification of the presence, and the availability, of an AR message, the type of virtual object, the type of sensory output, and so on. The interact tab 36 may permit a user to define an interaction between the AR element and a real object, another AR element, a virtual object, and so on, or combinations thereof. For example, the user may define the process, and the type, of real object that will be recognized for the interaction, or other AR element and virtual object the user's AR element will interact with, and so on. Similarly, the guide tab 38 permits a user to guide the conduct of the AR element. For example, the user may select the process of the recognition of real objects (e.g., radio frequency identification), the process of defining a route to be followed by the AR element (e.g., laser beam emission), and so on. The user may select any of the features described herein (e.g., element, message, object, output, interactions, etc.) from a database, or may create new features to be stored and employed. The illustrated communication tab 40 permits the user to define the communication of data, such as an AR element conduct, a generated AR element, a virtual object, a sensory output, an input, a determination of an implementation, an input designation, an implementation designation, an association, and so on. For example, a user may select the type of data to be communicated and a remote system with which to communicate the data.

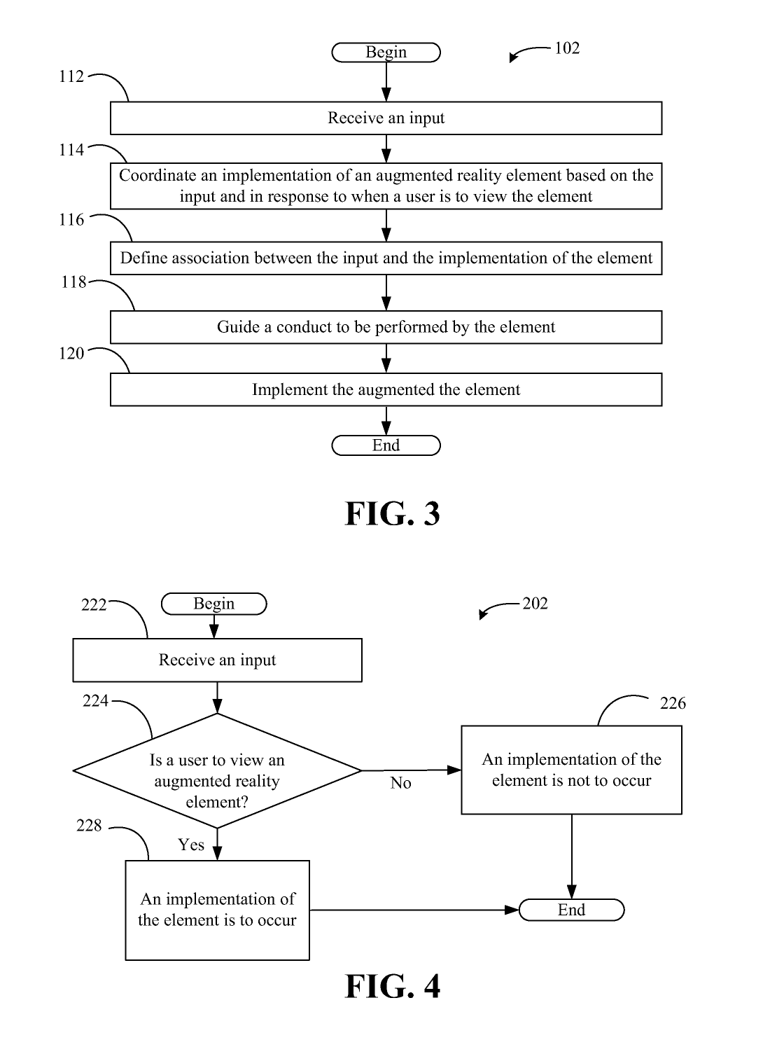

FIG. 3 shows a method 102 to implement an AR element. The method 102 may be implemented as a set of logic instructions and/or firmware stored in a machine- or computer-readable storage medium such as random access memory (RAM), read only memory (ROM), programmable ROM (PROM), flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), CMOS or transistor-transistor logic (TTL) technology, or any combination thereof. For example, computer program code to carry out operations shown in the method 102 may be written in any combination of one or more programming languages, including an object oriented programming language such as C++ or the like and conventional procedural programming languages, such as the “C” programming language or similar programming languages. Moreover, the method 102 could be implemented using any of the aforementioned circuit technologies.

Illustrated processing block 112 provides for receiving an input. The input may be received from a variety of sources, including online servers, disk drives, hard drives, storage, memory, software, sensors, and so on, or combinations thereof. The input may be received at any platform, such as a laptop, personal digital assistant (PDA), wireless smart phone, media content player, imaging device, mobile Internet device (MID), any smart device such as a smart phone, smart tablet, smart TV, and so on, or combinations thereof. The input may also be received at any stage or component of an AR pipeline, including a sensor, network interface component, memory, storage, hard disk, operating system, application, and so on, or combinations thereof. In one embodiment, a local sensor may provide the input. For example, the input may be captured and provided by a local sensor (e.g., accelerometer) of a user's device. In addition, a remote sensor may provide the input. For example, a remote server, a sensor on a remote device, and so on, may capture and provide the input.

The input may include a gesture input, for example from a motion sensor. In one embodiment, the gesture input may include a motion input, a sound input, and so on, or combinations thereof. For example, the motion input may include an acceleration of a device, a gyration of a device, and so on, or combinations thereof. The sound input may include any sound, such as a cough, sneeze, hum, yawn, laugh, and so on, or combinations thereof. In addition, the input may include an audio input, for example from an audio sensor. In one embodiment, the audio input may also include any sound or speech. For example, the audio input may include a word, a sentence, a command, and so on, or combinations thereof. Moreover, the input may include a user feature motion input. In one embodiment, the user feature motion input may include the motion of any feature of the user. For example, the user feature motion input may include user eye motion, finger motion, lip motion, appendage motion, and so on, or combinations thereof.

Additionally, the input may include an environmental input, for example from an environmental sensor. In one embodiment, the environmental input may be from a light sensor, such as an ultraviolet light sensor, to provide an environmental input related to light (e.g., UV level). The environmental input may include a remote sensor, for example a precipitation sensor that is located outdoors, to measure and provide rainfall data. The environmental sensor may also include a soft sensor, for example a soft sensor from an Internet service to process a measurement (e.g., weather measurements). The soft sensor may provide a measurement related to in a predetermined area, such as a zip code. In addition, the environmental input may include climate input, for example from an environmental sensor such as a climate sensor. In one embodiment, the climate input may include a climate parameter such as precipitation, temperature, pressure, elevation, humidity, time of day, sunshine, and so on, or combinations thereof.

Additionally, the input may include a real object select input, for example from a touch screen sensor. In one embodiment, the real object select input may include the selection of an object in a visual field of the user. For example, the real object select input may include selection of an inanimate object, such as a desk, an animate object, such as a person, a portion of a landscape, such as sky, and so on, or combinations thereof. Moreover, the input may include a guide input. In one embodiment, the guide input may include a motion input, an electromagnetic radiation input, and so on, or combinations thereof. For example, the electromagnetic radiation input may include a laser beam emission from a laser diode that has been captured.

Illustrated processing block 114 provides for coordinating an implementation of an AR element based on the input. In one embodiment, the AR element may include a character. For example, the character may include a caricature, an animated representation of an inanimate object, and so on, and combinations thereof. In addition, the AR element may include an AR scene. For example, the AR scene may include two or more AR elements interacting to form an AR illustration. Moreover, the AR element may include an AR effect. For example, an AR effect may include an effect representative of an environmental event. The AR effect may include shaking representative of an earthquake, turbulent flow representative of a flood, spinning representative of a tornado, shivering representative of a change in temperature, and so on, and combinations thereof. Any environmental event may have a represented related effect, including pressure, elevation, time of day, and so on, or combinations thereof.

The implementation of the AR element may not occur unless, or until, the input is determined or received. Moreover, the implementation of the AR element may be based on the input. In one embodiment, the implementation of the AR element may include the generation of the AR element, such as an AR character. For example, a user may employ a display device to provide a motion gesture towards a real object to cause the generation of the AR character, such that the AR character may appear on a screen of the display device among the real object in the visual field of the user. In addition, the implementation of an AR element may include the generation of an AR scene. For example, a user may employ a display device to provide a wave motion gesture to cause the generation of the AR scene, such as an AR caricature in an AR boat floating on a pond of AR water. Accordingly, the coordination of the implementation of the AR element may be based on the input, for example based the type of input that is determined or received.

In one embodiment, the implementation of an AR element may include the generation of an AR effect. For example, a user may employ the display device to provide a shake motion gesture to cause the generation of an AR shaking effect. An AR character may behave as if it is in an earthquake based on the AR shaking effect. Also, the presentation of an image by a display device may shake to represent the effect of the earthquake or the AR effect. The shake motion gesture may also cause the generation of an AR crack in the presentation of the image. The AR crack may interact with the AR effect, the AR character, and so on, or combinations thereof. In addition, the implementation of the AR element may include the generation of an AR message. For example, a first user may identify and select a real object in a visual field of the first user to generate an AR element, such as an animated representation based on the real object. The user may employ the display device to provide the input, such as gesture input, to define the conduct to be performed by the AR element. The AR message, including the AR element together with the behavior, may be left for a second user. A notification may be received alerting the second user that the AR message is present, for example as the second user nears the real object. The second user may view the AR message, for example by moving the real object into the visual field of the user using a display device.

In one embodiment, the implementation of the AR element may include the generation of a virtual object. For example, a user may employ a display device to provide an input, such as a circular motion gesture, to cause a virtual hoop to be generated based on the circular gesture input. In addition, the implementation of the AR element may include the generation of a sensory output. For example, a climate input, such as a high pollen count, may be received at a local display device from a remote sensor (e.g., outdoor sensor, soft sensor, etc.) and an AR character may sneeze based on the input.

In one embodiment, the implementation of the AR element may include an interaction with another element in the visual field of the user. For example, a user may make a motion gesture with a display device towards a real object and cause the interaction of an AR character with the real object on a screen of the display device. The interaction may be accomplished by recognizing the real object. A display device may include a radio frequency identification (RFID) reader to recognize a real object having an RFID tag. The user may provide an input, such as a motion gesture, near the real object having the RFID tag, which may indicate that a combination of the input and the real object is to trigger a presentation of the AR element, such as an AR scene including an AR character interacting with the real object on the screen of the display device.

In one embodiment, the interaction may also be accomplished by employing an image capture device, such as a camera, to capture the real object in the visual field and a touch sensor to allow the user to select the real object. In addition, the interaction may be accomplished by a determination that the real object is central in the visual field of the user and making the central object the subject of the interaction with the AR element. Accordingly, the user may employ the display device to provide a swipe motion gesture to cause an AR character to crawl across the real object on the screen of the display device. Moreover, the characteristics of the real object may influence the interaction. For example, if the real object is fluid, the interaction may include the AR character swimming in a bucket on the screen of the display device.

In one embodiment, the implementation of the AR element may include an interaction between the AR element and another AR element. For example, a first user may make a first gesture to control a first AR element on a first display device and a second user may make a second gesture to control a second AR element on a second display device. The first user and the second user may observe the interaction between the first AR element and the second AR element, in the same device or in their respective devices. The implementation may be accomplished by employing a network interface component to provide communication functionality. For example, a network interface component may provide communication functionality for a wide variety of purposes, such as cellular telephone (e.g., W-CDMA (UMTS), CDMA2000 (IS-856/IS-2000), etc.), WiFi (e.g., IEEE 802.11, 1999 Edition, LAN/MAN Wireless LANS), Bluetooth (e.g., IEEE 802.15.1-2005, Wireless Personal Area Networks), WiMax (e.g., IEEE 802.16-2004, LAN/MAN Broadband Wireless LANS), Global Positioning Systems (GPS), spread spectrum (e.g., 900 MHz), and other radio frequency (RF) telephony purposes. Accordingly, two users may control respective AR elements on respective display devices to cause an interaction, such as shaking hands that each user can observe on their respective display devices. In addition, the input, the implementation of the AR element, and so on, may be communicated between the devices to permit control of one or both of the AR elements by one or both of the users.

In one embodiment, the implementation of the AR element may include an interaction between an AR element and a virtual object. For example, a user may employ the display device to provide the input, such as a circular motion gesture input, to cause a virtual hoop to be generated. An AR element, such as an AR character, may interact with the virtual element by, for example jumping through the virtual hoop. In addition, the implementation of the AR element may include a conduct to be performed by the AR element irrespective of any other element in the visual field. For example, the implementation of the AR element may include the conduct to be performed by the AR element in response to the input, irrespective of any other element in the visual field.

In one embodiment, the implementation of the AR element may include employing a guide input to guide the implementation (e.g., conduct, trajectory, interaction, etc.) of the AR element. For example, a user may employ a motion sensor, such as an accelerometer or a gyrometer/gyroscope, to provide a motion input to determine a route to be followed by the AR element among real objects in a visual field of the user. An image capture device, such as a camera, may be employed to recognize the real object in the visual field or to capture the route. In addition, an electromagnetic radiation input from an electromagnetic radiation emitter may be employed to define the route to be followed by the AR element among real objects in the visual field. The image capture device may also be employed to recognize the real object, to recognize the electromagnetic radiation input, to capture the route, and so on, or combinations thereof.

In one embodiment, a relation between the input and the implementation of the AR element may be predefined or stored for retrieval. For example, a database may include the relation between the input, such as a gesture input, and the implementation of the AR element, such as an AR conduct. The database may be located on a remote server relative to a display device or a user, may be stored on local storage or memory relative to the display device or the user, and so on, or combinations thereof. Accordingly, when the input is received or determined, the database may provide the relation to be employed in the coordination of the implementation of the AR element.

Illustrated processing block 114 also provides for coordinating the implementation of the AR element in response to when the user is to view the AR element. In one embodiment, the implementation of the AR element is not to occur unless, or until, a user is viewing the AR element. For example, the user may provide a gesture input (e.g., twirl a display device) to control the conduct of the AR element based on the input (e.g., AR character twirl). The AR character may not behave in accordance with the gesture input unless, or until, the user is to view or is viewing the AR element. The AR element may be presented or may behave in accordance with the gesture input when the user is in a position to view, or is viewing, the AR element. Accordingly, the coordination of the implementation is based on whether the user is to view the AR element, for example occurring only when the user is to view the AR element.

In one embodiment, a determination that the user is to view, or is viewing, the AR element may be accomplished by employing an image capture device. For example, the image capture device, such as a camera, may be employed to determine that the user is in a position to view, or is viewing, a display device to present the AR element. The image capture device may also be employed to determine that the user is in a position to view, or is viewing, a window on the display device to present the AR element. The image capture device may also be employed to determine that the user is facing in a direction where a projection of the AR element is to be presented. Accordingly, unless or until the user is to view the AR element, there is not any unnecessary utilization of resources from the unnecessary implementation of the AR element. In addition, the user will not miss the implementation of the AR element.

Illustrated processing block 116 provides for defining an association between the input and the implementation of the AR element. In one embodiment, the user may designate the input to be employed in the association, the implementation of the AR element to be employed in the association, and so on, or combinations thereof. For example, the user may designate any input, such as an audio gesture input (e.g., a hum), to be employed in the association. The user may select the input from a database, or may create the input and store it for use. In addition, the user may designate any implementation of the AR element, such as a generation of the AR element (e.g., AR character), an interaction of the AR element, a conduct of the AR element, and so on, to be employed in the association. The user may select any feature described herein from a database, or may create any feature and store it for use. Moreover, the user may associate the input with the implementation of the AR element. For example, the user may associate an input (e.g., a hum) with an AR element implementation, such as a conduct of the AR element (e.g., AR element is to jump). Accordingly, the association may be employed when the input is determined or received, when the input or implementation is defined or received, when the association is defined or receive, and so on, or combinations thereof.

In one embodiment, the designation of the input, the designation of the implementation of the AR element, or the association between the input and the implementation of the AR element may be stored for retrieval. For example, a database may include the association between the input, such as a gesture input, and the implementation of the AR element, such as an AR element generation or conduct. The database may be located on a remote server relative to a display device or a user, may be stored on local storage or memory relative to the display device or the user, and so on, or combinations thereof. Accordingly, when the input or the implementation is determined or received, the database may provide the association to be employed. The conduct of an AR element may be tailored by the user, such as when the user defines the association.

Illustrated processing block 118 provides for guiding the implementation of the AR element, such as the conduct AR element. In one embodiment, the user may employ a sensor, such as a motion sensor, to provide a motion input to determine a route to be followed by the AR element among a real object in a visual field of the user. The user may employ a sensor, such as an image capture device, to recognize the real object in the visual field or to capture the route. In addition, the user may employ an electromagnetic radiation emitter, such as a laser diode, to provide an electromagnetic radiation emission input, such as a laser beam input, to define the route to be followed by the AR element among the real object in the visual field. The user may also employ the image capture device to recognize the real object, to recognize the electromagnetic radiation input, to capture the route, and so on, or combinations thereof.

Illustrated processing block 120 provides for implementing the AR element. In one embodiment, the AR element may be implemented by providing, rendering, presenting, displaying, or projecting the AR element. For example, the AR element may be provided on a screen of a display device, by an integrated projector, and so on, or combinations thereof. The AR element may be implemented by storing the AR element, retrieving the AR element from storage, and so on, or combinations thereof. The AR element may be implemented in accordance with any aspect of embodiments described herein.

Turning now to FIG. 4, a method 202 provides for coordinating an implementation of an AR element. The method 202 could be implemented using any of the herein mentioned technologies. The illustrated processing block 222 receives an input. A determination may be made at block 224 as to whether a user is viewing or is about to view an AR element. For example, the determination may be made as to whether the user is in a position to view, or is viewing, a display device, a window of the display device, in a direction of the projection of the AR element, and so on, or combinations thereof. If not, the illustrated processing block 226 may determine that the implementation of the AR element is not to occur. For example, the input and the implementation may be stored in memory and not retrieved unless, or until, the user is to the view the AR element. In addition, the input and the implementation may be unavailable for retrieval unless, or until, the user is viewing or is about to view the AR element. Moreover, the AR element may be generated or presented by the display device, but may not act unless, or until, the user is viewing or is about to view the AR element. If the user is viewing or is about to view the AR element, a determination may be made at processing block 228 that the implementation of the AR element is to occur. For example, the input and the implementation may be available for retrieval, may be retrieved, may be presented to the user, and so on, or combinations thereof. In addition, the AR element may perform an action, which may be defined by the user.

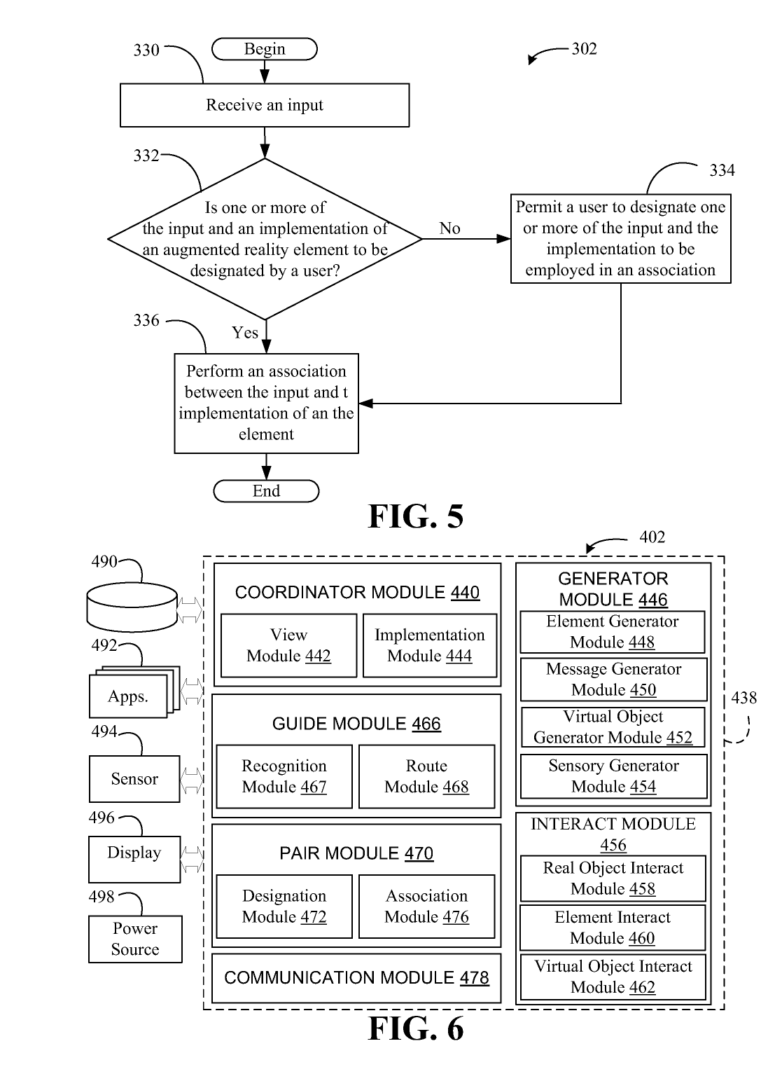

FIG. 5 shows a method 302 of performing an association between an input and an implementation of an AR element. The method 302 could be implemented using any of the herein mentioned technologies. The illustrated processing block 330 receives the input. A determination may be made at block 332 as to whether the input or the implementation is to be designated by a user. If not, the illustrated processing block 334 may permit the user to designate the input, the implementation, and combinations thereof. The designation of the input and the implementation may be stored in memory, or may be available for retrieval. If the input and the implementation are to be designated by the user, an association may be performed at processing block 336 to associate the input with the implementation. For example, the designated input and the designated implementation may be retrieved for employment in the association. In addition, the association may not be performed until a predefined event, for example until the user is viewing or is about to view the AR element, until the user is to approach a real object selected by the user, and so on, or combinations thereof. Moreover, the AR element may be generated or presented to the user to act in accordance with a user-defined behavior.

Turning now to FIG. 6, an apparatus 402 includes a logic architecture 438 to control the implementation an AR element. The logic architecture 438 may be generally incorporated into a platform such as such as a laptop, personal digital assistant (PDA), wireless smart phone, media player, imaging device, mobile Internet device (MID), any smart device such as a smart phone, smart tablet, smart TV and so on, or combinations thereof. The logic architecture 438 may be implemented in an application, operating system, media framework, hardware component, or combinations thereof. The logic architecture 438 may be implemented in any component of an AR pipeline, such as a network interface component, memory, processor, hard drive, operating system, application, and so on, or combinations thereof. For example, the logic architecture 438 may be implemented in a processor, such as central processing unit (CPU), a graphical processing unit (GPU), a visual processing unit (VPU), a sensor, an operating system, an application, and so on, or combinations thereof. The apparatus 402 may include a power source 498, such as a battery, a power connector, and so on, or combinations thereof.

In the illustrated example, the logic architecture 438 includes a coordinator module 440 to coordinate an implementation of an AR element based on an input and in response to when a user is viewing or is about to view the AR element. The input may be received at the logic architecture 438 from a variety of sources, from any platform, at any stage or component of an AR pipeline, and so on. For example, the input may be received from storage 490, applications 492, sensor 494, a network interface component (not shown), and so on, or combinations thereof. The illustrated coordinator module 440 includes a view module 442 to determine when the user is viewing or is about to view the AR element. In one embodiment, the implementation is not to occur unless, or until, the user is viewing the AR element. In addition, a determination that the user is viewing or is about to view the AR element may be accomplished by employing the sensor 494 (e.g., image capture device). For example, the sensor 494 may be employed to determine that the user is in a position to view, or is viewing, applications 492, display 496, and so on, or combinations thereof.

The illustrated coordinator module 440 also includes an implementation module 444 to determine the implementation of the AR element. In one embodiment, the implementation module 444 may determine that the implementation is to include a conduct to be performed by the AR element in response to the input, irrespective of any other element in the visual field of the user. For example, an input, such as a gesture input (e.g., shake motion input), may be received from the sensor 494 (e.g., an accelerometer). The implementation module 444 may determine that the conduct to be preformed by the AR element is to be based on the gesture input (e.g., an AR character is to act as if it is in an earthquake) irrespective of any other element in the visual field.

In one embodiment, the implementation module 444 may determine that the implementation is to include a generation of an AR character, an AR scene, an AR effect, and so on, or combinations thereof. The logic architecture 438 may include a generator module 446 having an element generator module 448 to generate the AR element. In addition, the implementation module 444 may determine that the implementation is to include a generation of an AR message, and the generator module 446 may include a message generator module 450 to generate the AR message. Moreover, the implementation module 444 may determine that the implementation is to include a generation of a virtual object, and the generator module 446 may include a virtual object generator module 452 to generate the virtual object. In addition, the implementation module 444 may determine that the implementation is to include a generation of a sensory output, and the generator module 446 may include a sensory generator module 454 to generate the virtual object.

Additionally, the implementation module 444 may determine that the implementation is to include an interaction between the AR element and a real object, another AR element, a virtual object, and so on, or combinations thereof. In one embodiment, the logic architecture 438 may include an interact module 456 having a real object interact module 458 to provide the interaction between the AR element and the real object. In addition, the interact module 456 may include an element interact module 460 to provide the interaction between the AR element and another AR element. The interact module 456 may also include a virtual object interact module 462 to provide the interaction between the AR element and the virtual object. The generator module 446 or the real object interact module 456 may include a recognition module, as described below, or may communicate with a recognition module to recognize the real object.

Additionally, the implementation module 444 may determine that the implementation is to include a guide input to guide the implementation (e.g., conduct) of the AR element. The logic architecture 438 may include a guide module 466 having a recognition module 467. In one embodiment, the recognition module 467 may recognize a real object in a visual field of the user by employing radio frequency identification (RFID) readers and tags to recognize the real object. In addition, the recognition module 467 may recognize a real object in the visual field by employing the sensor 494 (e.g., image capture device) to determine that an object is central in the visual field, thereby making the object the subject of the interaction. Moreover, the recognition module 467 may recognize the real object in the visual field by employing the sensor 494 (e.g., touch sensor) to determine which real object has been selected by the user.

In one embodiment, the guide module 466 may also include a route module 468. The route module 468 may employ the sensor 494 (e.g., motion sensor) to determine a route to be followed by the AR element. For example, movement of the sensor 494 (e.g., accelerometer) about a real object in the visual field may define the route to be followed by the AR element among the real object. In addition, the route module 468 may employ the sensor 494 (e.g., electromagnetic radiation emitter) to emit an electromagnetic radiation to define the route to be followed by the AR element among a real object in the visual field. The route module 468 may also employ the sensor 494 (e.g., image capture device) to recognize the electromagnetic radiation emitted, to capture the route, and so on, or combinations thereof.

In the illustrated example, the logic architecture 438 includes a pair module 470 to perform an association between the input and the implementation of the AR element, wherein the association is to be defined by the user. The illustrated pair module 470 includes a designation module 472 to permit the user to designate one or more of the input and the implementation to be employed in the association. For example, the pair module 470 may employ the display 496, applications 492, storage 490, and so on, to permit the user to select the input or the implementation to be employed in the association. The illustrated pair module 470 also includes an association module 476 to employ the input and the implementation in the association. For example, the association module may employ the display 496, applications 492, storage 490, and so on, to permit the user to perform an association by relating the input with the implementation.

In one embodiment, the coordinator module 440 and the pair module 470 are to be employed together. For example, the pair module 470 may permit the user to designate or associate the input with the implementation. The implementation module 444 may utilize the designation or the association from the pair module 470 to determine the implementation. In one illustrative example, the pair module 470 may permit the user to designate and associate an input, such as a gesture input (e.g., shake motion gesture), with an implementation, such as an AR element behavior (e.g., act as if in an earthquake), of the AR element (e.g., AR character). The implementation module 444 may determine that the implementation is to include an interaction with a real object (e.g., the ground), and the real object interact module 458 provides the interaction between the AR element and the real object including the user-defined designation and association (e.g., AR character acts as if in an earthquake on the ground).

In one embodiment, the logic architecture 478 may include a communication module 478. The communication module 478 may be connected, or integrated, with a network interface component (not shown). The communication module 478 may synchronously and bi-directionally communicate data, such as an AR element conduct, a generated AR element, a virtual object, a sensory output, an input, a determination of an implementation, a designation, an association, and so on, or combinations thereof. In addition, the communication module 478 may synchronously and bi-directionally communicate data with a remote system, the storage 490, the applications 492, the sensor 494 (e.g., projector), the display 496, so on, or combinations thereof. While examples have illustrated separate modules, it is apparent that one or more of the modules of the logic architecture 438 may be implemented in one or more combined modules.

FIG. 5 shows a block diagram of an example of a system 502 to implement an AR element. The system 502 may include a logic architecture 538 in combinations with other system components, such as a power supply 598 to supply power to the system, a display 596 to present the AR element, user interface system 582 to provide user input to the system 502, system memory (not shown), mass storage (not shown), network interface component (not shown), and so on, or combinations thereof. In addition, the system 502 may include dedicated components to receive or process an image, such as a dedicated graphic component including dedicated graphics memory (not shown). In one embodiment, the system 502 may include a coordinator module 540 to coordinate an implementation of an AR element based on the input, which may be received from user interface 582 system (e.g., a touch screen), and in response to when a user is viewing or is about to view the AR element, for example determined employing a sensor proximate to the display 596 (e.g., camera).

The system 502 may also include a pair module 570 to perform an association between the input and the implementation, wherein the association is to be defined by the user. For example, the pair module may employ the user interface system 582 together with the display 596 to permit the user to designate or associate the input and the implementation. In addition, the system 502 may include a generator module 546 to generate an AR element, an AR message, a virtual object, and a sensory output, or combinations thereof. Moreover, the system 502 may include an interact module 556, to perform an interaction between the AR element and a real object, another AR element, a virtual object, and so on, or combinations thereof.

The system 502 may also include a guide module 564 to guide the conduct of the AR element. For example, the guide module may employ RFID technology, an image capture device proximate to the display 596, or an electromagnetic radiation emitter proximate to the display 596 to recognize an object, to define a route, or capture a route in the visual field of the user. In addition, the system 502 may include a communication module, to communicate data to the local resources, such as the local memory (not shown), the local sensors (not shown), and so on, and combinations thereof. The communication module may also communicate with the remote system 584, which may include remote resources relative to the system 502. For example, a remote system 584 may provide a climate gesture input to be employed in the implementation. In one embodiment, the guide module 564 and the communication module 478 may be employed with either or both the coordinator module 440 and the pair module 570.

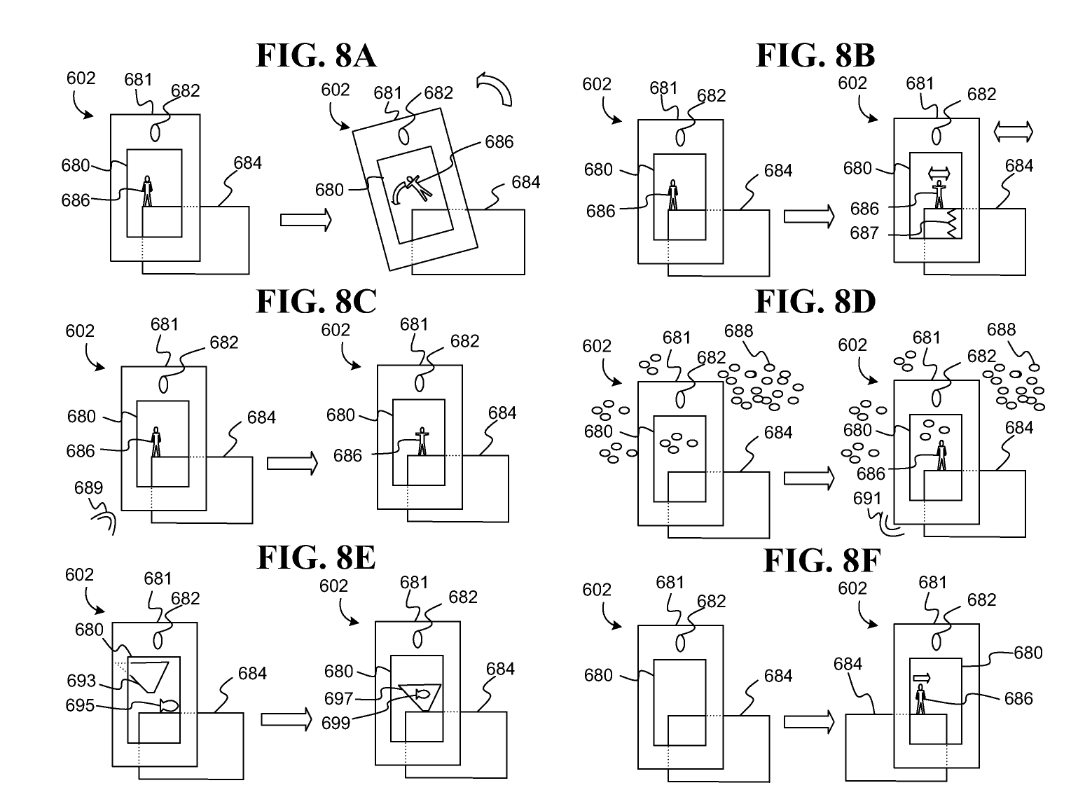

Turning to FIGS. 8A to 8F, screenshots of examples of implementations of AR elements are shown. FIG. 8A shows an apparatus 602 including a screen 680, a rear-facing camera 681 and a front-facing camera 682. The rear-facing camera 681 is to capture an image of a real object 684, which is in the visual field of a user, and the user is able to observe an AR element 686 (e.g., AR character) presented on the screen 680. The user may make a motion gesture by tipping the apparatus 602, such that the AR element 686 may perform a conduct (e.g., behavior is to fall off the real object 684). In one embodiment, the AR element 686 is not to perform the conduct until the user is about to view, or is viewing, the AR element, which may be determined employing the front-facing camera 682. In addition, the user may define an association between the AR element 686 and the input (e.g., tipping), for example employing the screen 680.

FIG. 8B shows that the user may provide a gesture input, such as shake motion input, by shaking the apparatus 602. In response, the AR element 686 may then act as if it were in an earthquake. In addition, an AR element 687 (e.g., AR crack) may appear. Moreover, an AR effect of shaking may cause the image observed on the screen 680, including the real object 684, to shake to represent the effect of the earthquake or the AR effect. FIG. 8C shows that an audio input 689 (e.g., sound) may be provided by the user to cause the AR element 686 to behave in accordance with the input or with a user-defined association. FIG. 8D shows that the apparatus 602 may not present any AR element, but instead may initially show the real object 684 and precipitation 688 (e.g., snow, rail, hail, etc.). The apparatus 602 may determine an input, such as a climate input, based on the recognition of the precipitation. Moreover, the apparatus 602 may receive a climate input, for example Doppler data from a remote server. An AR element 686 may be generated, and may include a sensory output 691 (e.g., sneeze). FIG. 8E shows that the rear-facing camera 681 is to capture the image of the real object 684 (e.g., a table), a real object 693 (e.g., a bowl), and a real object 695 (e.g., a fish), which is in the visual field of the user. The user may make a gesture, such as a motion gesture towards the real objects 684, 693 or 695. An AR scene is generated, including an AR character 699 (e.g., AR fish character) swimming in an AR character (e.g., AR bowl 697), where each are disposed on the real object 684 (e.g., table 684).

FIG. 8F shows that the rear-facing camera 681 is to capture the image of the real object 684. The user may make a gesture, such as a motion gesture to swipe the apparatus 602 across the real object 684. An AR element 686 (e.g., AR character) may then appear and walk across the real object 684 in a rout defined in accordance with a guide input. In one embodiment, the user may employ an electromagnetic radiation emitter to provide the guide input and define the route. For each of the examples illustrated in FIGS. 8A to 8F, the implementation of the AR element may be based on the input, based on when the user is viewing or is about to view the AR element, a user-defined association, or combinations thereof.

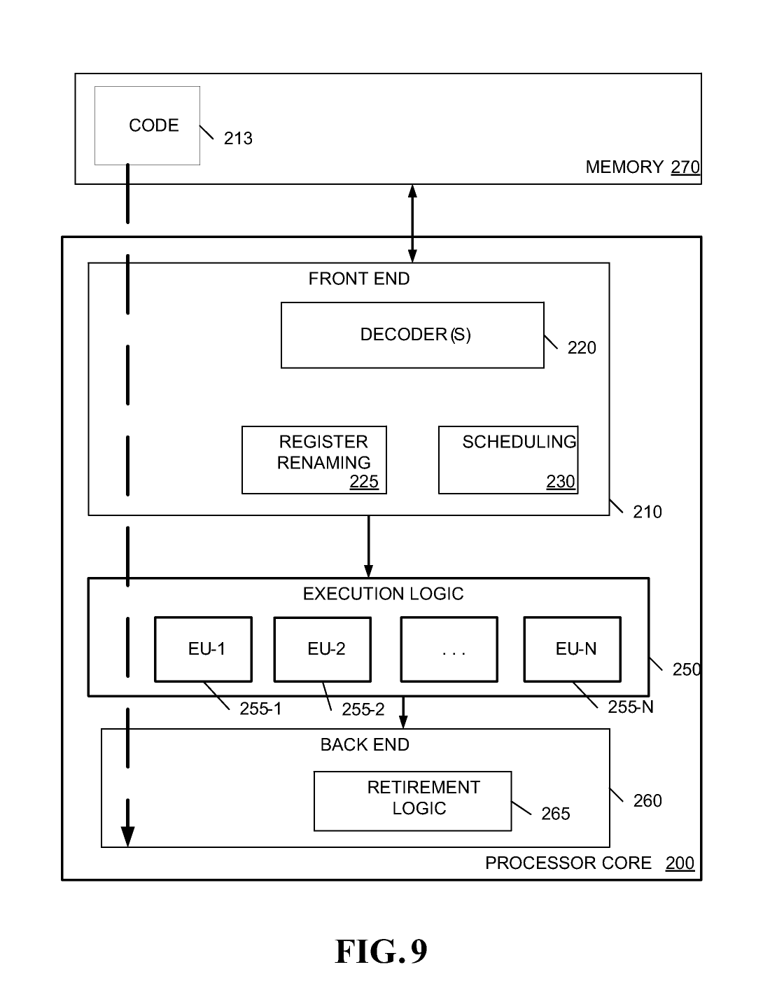

FIG. 9 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 9, a processing element may alternatively include more than one of the processor core 200 illustrated in FIG. 9. The processor core 200 may be a single-threaded core or, for at least one embodiment, the processor core 200 may be multithreaded in that it may include more than one hardware thread context (or “logical processor”) per core.

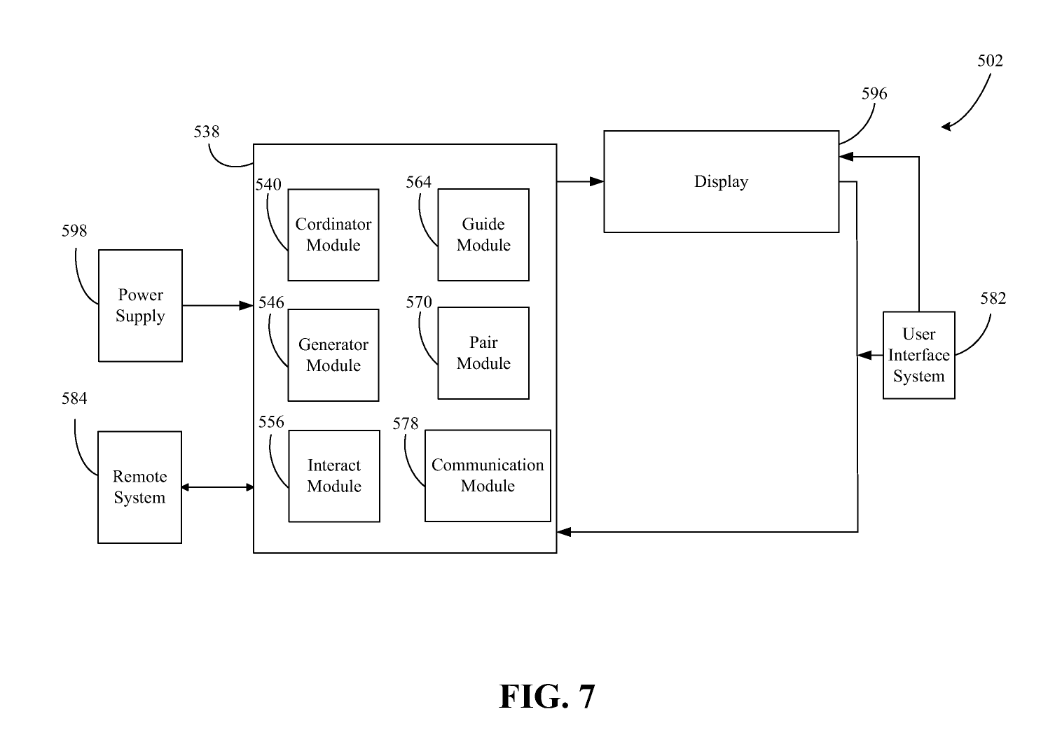

FIG. 9 also illustrates a memory 270 coupled to the processor 200. The memory 270 may be any of a wide variety of memories (including various layers of memory hierarchy) as are known or otherwise available to those of skill in the art. The memory 270 may include one or more code 213 instruction(s) to be executed by the processor 200 core, wherein the code 213 may implement the logic architecture 438 (FIG. 6) or the logic 538 (FIG. 7), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end 210 also includes register renaming logic 225 and scheduling logic 230, which generally allocate resources and queue the operation corresponding to the convert instruction for execution.

The processor 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 9, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

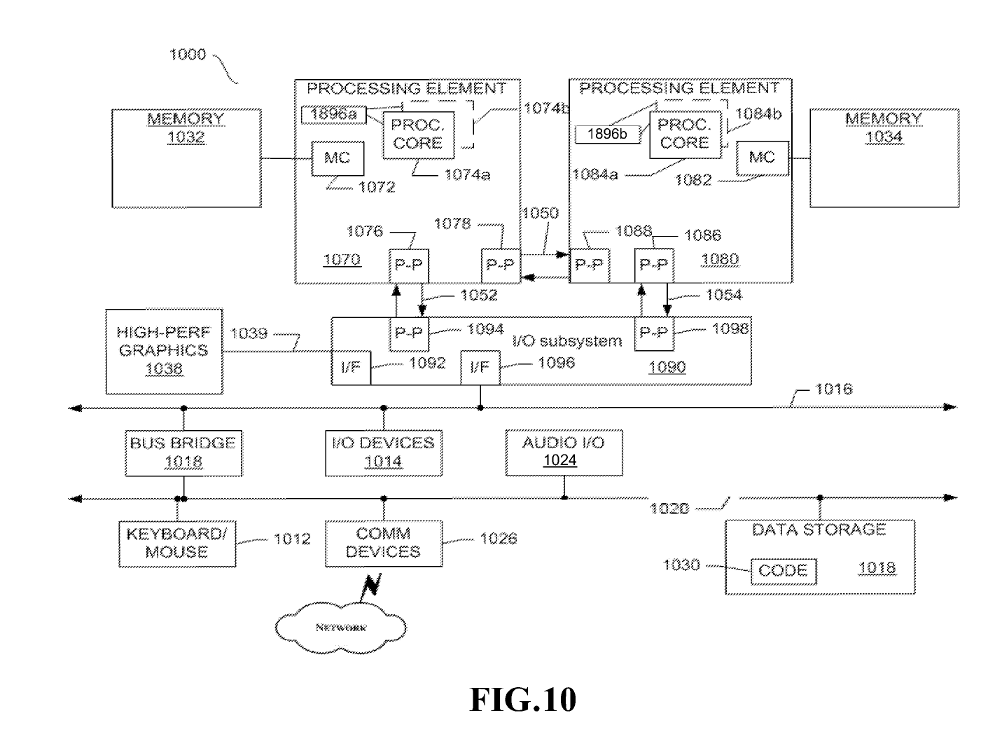

Referring now to FIG. 10, shown is a block diagram of a system embodiment 1000 in accordance with an embodiment of the present invention. Shown in FIG. 10 is a multiprocessor system 1000 that includes a first processing element 1070 and a second processing element 1080. While two processing elements 1070 and 1080 are shown, it is to be understood that an embodiment of system 1000 may also include only one such processing element.

System 1000 is illustrated as a point-to-point interconnect system, wherein the first processing element 1070 and second processing element 1080 are coupled via a point-to-point interconnect 1050. It should be understood that any or all of the interconnects illustrated in FIG. 10 may be implemented as a multi-drop bus rather than point-to-point interconnect.

As shown in FIG. 10, each of processing elements 1070 and 1080 may be multicore processors, including first and second processor cores (i.e., processor cores 1074a and 1074b and processor cores 1084a and 1084b). Such cores 1074, 1074b, 1084a, 1084b may be configured to execute instruction code in a manner similar to that discussed above in connection with FIG. 9.

Each processing element 1070, 1080 may include at least one shared cache 1896. The shared cache 1896a, 1896b may store data (e.g., instructions) that are utilized by one or more components of the processor, such as the cores 1074a, 1074b and 1084a, 1084b, respectively. For example, the shared cache may locally cache data stored in a memory 1032, 1034 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the present invention is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, microarchitectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

First processing element 1070 may further include memory controller logic (MC) 1072 and point-to-point (P-P) interfaces 1076 and 1078. Similarly, second processing element 1080 may include a MC 1082 and P-P interfaces 1086 and 1088. As shown in FIG. 8, MC's 1072 and 1082 couple the processors to respective memories, namely a memory 1032 and a memory 1034, which may be portions of main memory locally attached to the respective processors. While the MC logic 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076, 1086 and 1084, respectively. As shown in FIG. 10, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple graphics engine 1038 to I/O subsystem 1090. Alternately, a point-to-point interconnect 1039 may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the present invention is not so limited.

As shown in FIG. 10, various I/O devices 1014 such as the screen 14 (FIG. 1), the screen 26 (FIG. 2), the display 496 (FIG. 6) or the display 596 (FIG. 7) may be coupled to the first bus 1016, along with a bus bridge 1018 which may couple the first bus 1016 to a second bus 1010. In one embodiment, the second bus 1020 may be a low pin count (LPC) bus. Various devices may be coupled to the second bus 1020 including, for example, a keyboard/mouse 1012, communication device(s) 1026 (which may in turn be in communication with a computer network), and a data storage unit 1018 such as a disk drive or other mass storage device which may include code 1030, in one embodiment. The code 1030 may include instructions for performing embodiments of one or more of the methods described above. Thus, the illustrated code 1030 may implement the logic architecture 438 (FIG. 6) or the logic architecture 538 (FIG. 7) and could be similar to the code 213 (FIG. 9), already discussed. Further, an audio I/O 1024 may be coupled to second bus 1020.

Note that other embodiments are contemplated. For example, instead of the point-to-point architecture of FIG. 10, a system may implement a multi-drop bus or another such communication topology. Also, the elements of FIG. 10 may alternatively be partitioned using more or fewer integrated chips than shown in FIG. 10.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated. Additionally, it is understood that the indefinite articles “a” or “an” carries the meaning of “one or more” or “at least one”.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A system comprising:
a power supply to provide power to the system;
a coordinator module to coordinate an implementation of an augmented reality element based on an input and in response to when a user is to view the element; and
a display to present the element.

2. The system of claim 1, further comprising one of more of:
a motion sensor;
an audio sensor;
an image sensor;
a touch sensor; and
an environmental sensor.

3. The system of claim 2, wherein the environmental sensor is to include one or more of:
a light sensor;
an outdoor sensor; and
a soft sensor.

4. The system of claim 2, wherein the environmental sensor is to include a climate sensor.

5. The system of claim 1, wherein the coordination module is to include one or more of:
an implementation module to determine the implementation of the element; and
a view module to determine when the user is to view the element.

6. The system of claim 1, further comprising one or more of:
a generator module to generate one or more of the element, an augmented reality message, a virtual object, and a sensory output;
a guide module to guide a conduct of the element; and
a communication module to communicate one or more of the input and the implementation to a remote system.

7. The system of claim 6, wherein the guide module is to include one or more of:
a recognition module to recognize a real object in a visual field; and
a route module to define a route relative to the real object to be followed by the element.

8. The system of claim 6, wherein the communication module is to communicate a gesture input to the remote device to cause the implementation of the element by the remote device.

9. A computer-readable medium comprising one or more instructions that when executed on a processor cause the processor to:
receive an input; and
coordinate an implementation of an augmented reality element based on the input and in response to when a user is to view the element.

10. The medium of claim 9, wherein the input is to include one or more of a gesture input, an audio input, a user feature motion input, a climate input, a real object select input, and a guide input, and wherein the element is to include one or more of an augmented reality character, an augmented reality scene, and an augmented reality environmental effect.

11. The medium of claim 9, wherein the input is to be determined by one or more of a local sensor and a remote sensor.

12. The medium of claim 9, wherein when executed the one or more instructions configure a processor to cause the implementation to include one or more of a generation and a receipt of one or more of the element, an augmented reality message, a virtual object, and a sensory output.

13. The medium of claim 9, wherein when executed the one or more instructions configure a processor to cause the implementation to include an interaction between the element and one or more of a real object, another augmented reality element, and a virtual object.

14. The medium of claim 9, wherein when executed the one or more instructions configure a processor to cause the implementation to include a guide input to guide a conduct of the element.

15. The medium of claim 9, wherein when executed the one or more instructions configure a processor to cause the implementation to include a generation of the element based on a real object select input, and to include a gesture input to define a conduct of the element.

16. The medium of claim 9, wherein when executed the one or more instructions configure a processor to cause a communication of one or more of the input and the implementation to a remote system.

17. A system comprising:
a power supply to provide power to the system;
a pair module to perform an association between an input and an implementation of an augmented reality element, wherein the association is to be defined by a user; and
a display to present the element.

18. The system of claim 17, further comprising one of more of:
a motion sensor;
an audio sensor;
an image sensor;
a touch sensor; and
an environmental sensor.

19. The system of claim 17, wherein the pair module is to include one or more of:
a designation module to permit the user to designate one or more of the input and the implementation to be employed in the association; and
an association module to employ the input and the implementation in the association.

20. The system of claim 17, further comprising one or more of:
a generator module to generate one or more of the element, an augmented reality message, a virtual object, and a sensory output;
a guide module to guide a conduct of the element; and
a communication module to communicate one or more of the input and the implementation to a remote system.

21. The system of claim 20, wherein the guide module is to include one or more of:
a recognition module to recognize a real object in a visual field; and
a route module to define a route relative to the real object to be followed by the element.

22. The system of claim 20, wherein the communication module is to communicate a gesture input to the remote system to cause the implementation of the element by the remote system.

23. A computer-readable medium comprising one or more instructions that when executed on a processor cause the processor to:
receive an input; and
perform an association between the input and an implementation of an augmented reality element, wherein the association is to be defined by a user.

24. The medium of claim 23, wherein the user is to designate one or more of the input and the implementation to be employed in the association.

25. The medium of claim 23, wherein the input is to include one or more of a gesture input, an audio input, a user feature motion input, a climate input, a real object select input, and a guide input, and wherein the element is to include one or more of an augmented reality character, an augmented reality scene, and an augmented reality environmental effect.

26. The medium of claim 23, wherein when executed the one or more instructions configure a processor to cause the implementation to include one or more of a generation and a receipt of one or more of the element, an augmented reality message, a virtual object, and a sensory output.

27. The medium of claim 23, wherein when executed the one or more instructions configure a processor to cause the implementation to include an interaction between the element and one or more of a real object, another augmented reality element, and a virtual object.

28. The medium of claim 23, wherein when executed the one or more instructions configure a processor to cause the implementation to include a guide input to guide a conduct of the element.

29. The medium of claim 23, wherein when executed the one or more instructions configure a processor to cause the implementation to include a generation of the element based on a real object select input, and to include a gesture input to define a conduct of the element.

30. The medium of claim 23, wherein when executed the one or more instructions configure a processor to cause a communication of one or more of the input and the implementation to a remote system.
